(19) United States
(12) Patent Application Publication
(10) Pub. No.: US 2012/0272045 A1
(43) Pub. Date: Oct. 25, 2012

(54) CONTROL METHOD AND SYSTEM OF MULTIPROCESSOR

(75) Inventor: Shih-Jen Chuang, Chupei City (TW)

(73) Assignee: FEATURE INTEGRATION TECHNOLOGY INC., Chupei City (TW)

(21) Appl. No.: 13/223,426

(22) Filed: Sep. 1, 2011

(30) Foreign Application Priority Data
Apr. 22, 2011 (TW) 100114179

(51) Int. Cl. G06F 9/312

(52) U.S. Cl. 712/214; 712/E09.033

(57) ABSTRACT

A control method and a system for dispatching the execution sequence of the processes in a multiprocessors system so as to dispatch an operation sequence for executing different operation programs by a monitoring processor and a plurality of target processors. The monitoring processor obtains operation status of other processors from a buffer; the monitoring processor selects at least one target processor according to the operation status; the monitoring processor assigns the target processor to execute a corresponding slave operation program, and modifies the operation status of the target processors in the buffer module; and the monitoring processor repeats the setting the operation status and assigning other target processors to execute corresponding operation programs, till a master operation program is completed.

### CROSS-REFERENCE TO RELATED APPLICATIONS

This non-provisional application claims priority under 35 U.S.C. §119(a) on Patent Application No(s). 100114179 filed in Taiwan, R.O.C. on Apr. 22, 2011, the entire contents of which are hereby incorporated by reference.

### BACKGROUND

1. Field of Invention The disclosure relates to a flow control method and system, and more particularly to an operation control method and system of a multiprocessor.

2. Related Art

The progress of the manufacturing process on integrated circuits (ICs) enables a small processor to have superior operation performance. The development of the processor is from a single processor providing a single operational capability in the past to a multiprocessor providing operational capability individually, and then, to a single processor providing multi-threaded operational capability, and finally, to a multiprocessor providing multithreaded operation. Multi-threaded processors are launched to solve the performance problem of single-threaded processors. Due to increase on demand of the performance of processors, multi-processor capable of running multi threads is developed.

In a procedure of the multiprocessor, the processors run a resource allocation procedure to prevent each processor from being in an idle state. Therefore, the processors acquires loads of the processors through polling or interrupt method.

The conventional polling is that an initiating processor continuously inquires the other processors and checks whether the other processors have completed a previous instruction. The initiating processor cannot send a next instruction until the other processors have completed the instruction. Although the polling method can ensure that each processor has processes and resources thereof to use, the initiating processor needs to wait for a response of the processors in the polling, so as to send the next instruction; therefore, the waiting time of the polling may be longer than the running time.

The interrupt processing method is proposed to shorten the waiting time of the polling. The interrupt processing only includes temporarily invoking a processor to execute work of other devices. Once the interrupt occurs, the processor stores status information of a buffer at that time. After the interrupt task is completed, the operation is restarted according to the status information. In other words, the processor needs to temporarily stop the work program and handle relevant interrupt tasks, and finally the processor must be provided with a capability to restore normal work, so as to continue the uncompleted program after handling the interrupt. Compared with the polling processing, the interrupt processing may not need to wait for a response of the other processors, so the initiating processor may send an interrupt request to different processors. Although the interrupt processing may reduce the waiting time, more hardware resources need to be used to record the status of the processors in the interrupt processing procedure.

Therefore, in the allocation processing procedure of the multiprocessor (for example, the polling processing or the interrupt processing), problems of too long waiting time and high consumption of hardware resources occur.

### SUMMARY OF THE INVENTION

Accordingly, the disclosure is a control method of a multiprocessor, so as to dispatch an operation sequence for executing different operation programs by a monitoring processor and a plurality of target processors.

The disclosure provides a control method of a multiprocessor, which comprises: a monitoring processor executing a master operation program; the monitoring processor obtaining an operation status of other target processors from a buffer; the monitoring processor selecting at least one target processor; the monitoring processor resetting the operation status value of the other selected target processors, so that the other target processors execute corresponding slave operation program according to the new operation status; the monitoring processor repeating the step of setting the operation status, till the monitoring processor completes the master operation program; and the monitoring processor clearing the operation status of the other target processors in the buffer after the monitoring processor completes the master operation program.

The disclosure further provides an operation control system of a multiprocessor, which comprises a monitoring processor, target processors, and a buffer. When the monitoring processor and the target processors execute programs individually, the processors write statuses thereof into the buffer. The monitoring processor executes a master operation program, and obtains an operation status of other target processors from the buffer; the monitoring processor selects at least one target processor; the monitoring processor resets the operation status of the other selected target processors, so that the other target processors execute the corresponding slave operation program according to the new operation status; the monitoring processor repeats the step of setting the operation status, till the monitoring processor completes the master operation program; and the monitoring processor clears the operation status of the other target processors in the buffer after the monitoring processor completes the master operation program.

According to the disclosure, the control method and the system of the multiprocessor are used for dispatching an operation sequence for executing different operation programs by a plurality of processors. According to the disclosure, the processors obtain the use status of the other processors without using an interrupt or polling method. Therefore, according to the disclosure, the time consumed for inquiring may be reduced in the allocation procedure of the multiprocessor, thereby improving the operation efficiency of the processors.

### BRIEF DESCRIPTION OF THE DRAWINGS

The disclosure will become more fully understood from the detailed description given herein below for illustration only, and thus are not limitative of the disclosure, and wherein:

FIG. 1 is a schematic architectural view of the disclosure;

FIG. 2 is a schematic view illustrating an operational process of the disclosure;

FIG. 3A is a schematic structural view of a slave operation program according to the disclosure;

FIG. 3B is a schematic view of a buffer module according to the disclosure;

FIG. 3C is a schematic view of operation of a whole architecture according to the disclosure;

FIG. 3D shows a program counter (PC) and a program status (PS) value of a target processor according to the disclosure;

FIG. 3E shows a PC and a PS value of a target processor according to the disclosure;

FIG. 3F shows a PC and a PS value of a target processor according to the disclosure; and

FIG. 4 is a schematic view of pulse signals in operation according to the disclosure.

### DETAILED DESCRIPTION

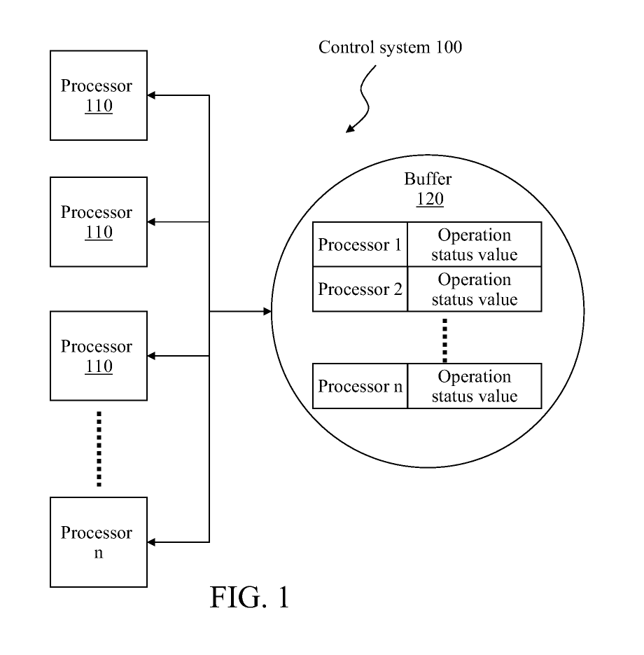

The disclosure may be applied to, for example, a tablet computer, a personal computer, a smart phone or a personal digital assistant (PDA) with an integrated circuit chip having a multiprocessor. FIG. 1 is a schematic architectural view of the disclosure. Referring to FIG. 1, a control system 100 of the disclosure comprises a plurality of processors 110 and a buffer module 120. Each processor 110 communicates with the buffer module 120.

One processor selected from the processors 110 in operation is defined as a monitoring processor 111, and the other processors are assigned as target processors 112. The monitoring processor 111 assigns other target processors 112 to execute a corresponding operation program. The monitoring processor 111 determines a number of the target processors 112 according to a load demand of a master operation program or processors 110 in idle. The operation program currently executed by the monitoring processor 111 is defined as the master operation program. The operation program executed by the target processors 112 that are assigned by the monitoring processor 111 is defined as a slave operation program 131.

The buffer module 120 stores operation statuses when the processors execute the operation programs, and the operation status at least comprises an identification code of the processor, a program counter (PC), a program status (PS) value, and a writing flag or a reading flag. When the processors execute the operation programs, the processors update the corresponding operation status in real time. Therefore, the monitoring processor 111 may determine whether the processors are in use according to the operation status. Furthermore, the operation status may be used to determine whether the processors are assigned to be the target processors 112. If more than two target processors 112 are required during a running period of the master operation program, the monitoring processor 111 may determine whether the processors are assigned to be the target processors 112 according to load levels of the processors 110. For example, if the PC and the PS value are “0” at the same time, it is indicated that the processor 110 is totally idly; or it is set that the processor 110 is regarded to be idle or busy when the PC or the PS value is below a particular threshold. The buffer module 120 may be implemented in a queue or stacking manner.

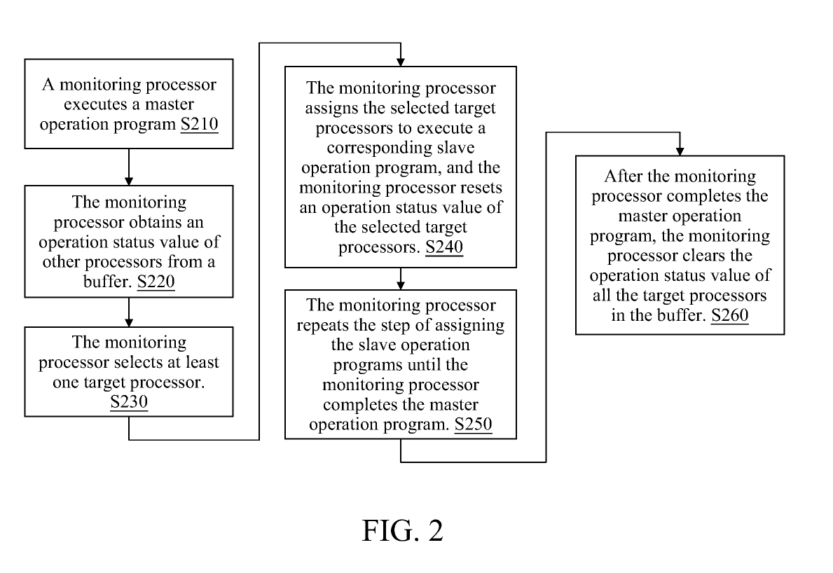

FIG. 2 is a schematic view illustrating an operational process of the disclosure. Referring to FIG. 2, the control method of a multiprocessor according to the disclosure comprises the following steps.

In Step S210, a monitoring processor executes a master operation program.

In Step S220, the monitoring processor obtains an operation status of other target processors from a buffer.

In Step S230, the monitoring processor selects at least one target processor.

In Step S240, the monitoring processor assigns the selected target processors to execute a corresponding slave operation program, and the monitoring processor resets the operation status of the selected target processors.

In Step S250, the monitoring processor repeats the step of assigning the slave operation programs, till the monitoring processor completes the master operation program.

In Step S260, after the monitoring processor completes the master operation program, the monitoring processor clears the operation status of all the target processors in the buffer.

First, the monitoring processor 111 executes the master operation program. The monitoring processor 111 obtains the operation statuses of other target processors 112 from the buffer. The monitoring processor 111 determines the target processors 112 to be assigned according to the obtained operation status. For example, the monitoring processor 111 may select processors having a PC or PS value being “0” as the target processors 112.

After the monitoring processor 111 selects the target processor 112, the monitoring processor 111 assigns the selected target processors 112 to execute a corresponding slave operation program 131. At the same time, the monitoring processor 111 resets the operation status of the selected target processors 112 to prevent other monitoring processors 111 to use the assigned target processors 112. The monitoring processor 111 repeatedly drives the target processors 112 to execute the corresponding slave operation program 131, till the monitoring processor 111 completes the master operation program.

Finally, when the monitoring processor 111 completes the master operation program, the monitoring processor 111 clears the operation status of all the target processors 112 in the buffer, so as to release the right to use the target processors 112. According to the disclosure, the monitoring processor 111 assigns the slave operation programs 131 to different target processors 112 in a pipeline manner, so that each target processor 112 may individually handle the slave operation program 131 thereof.

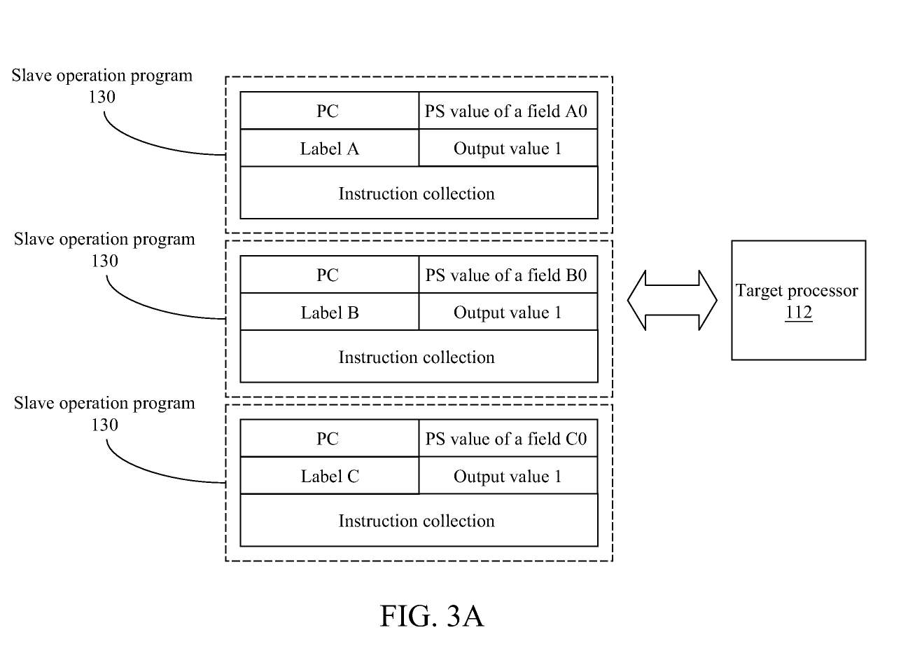

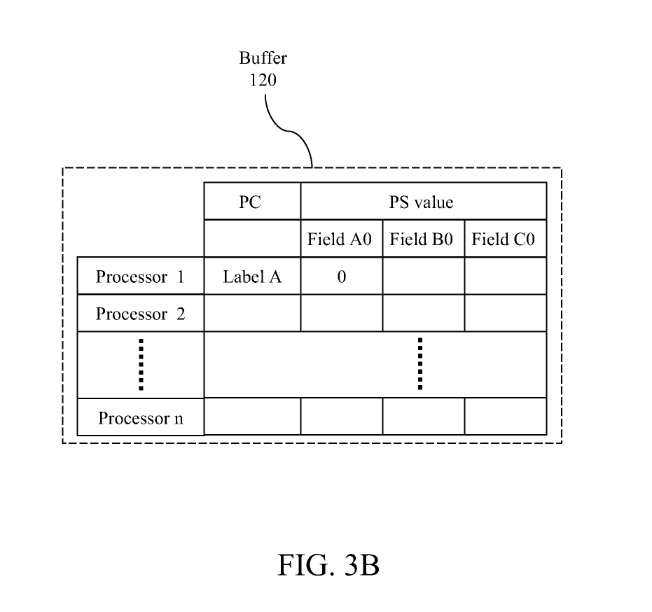

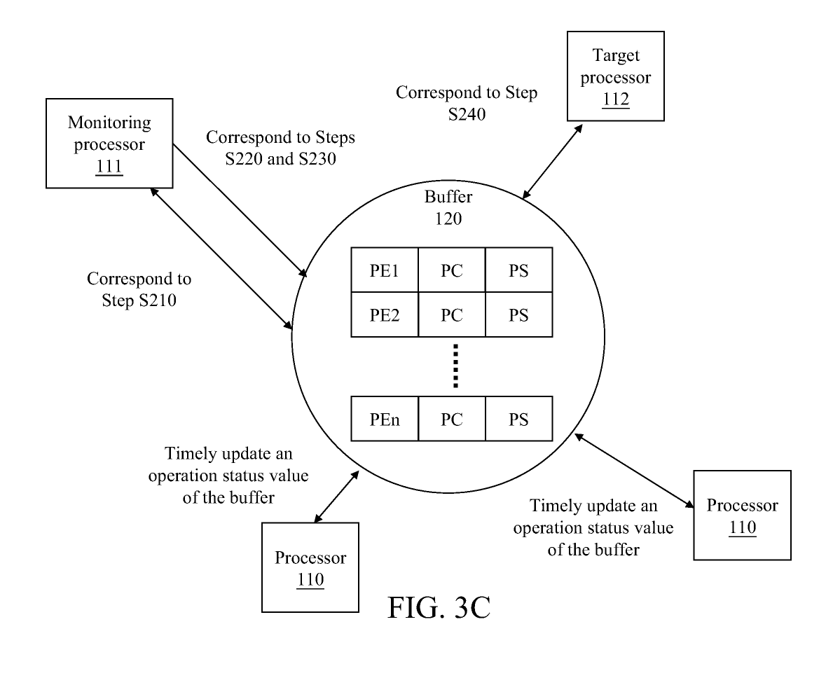

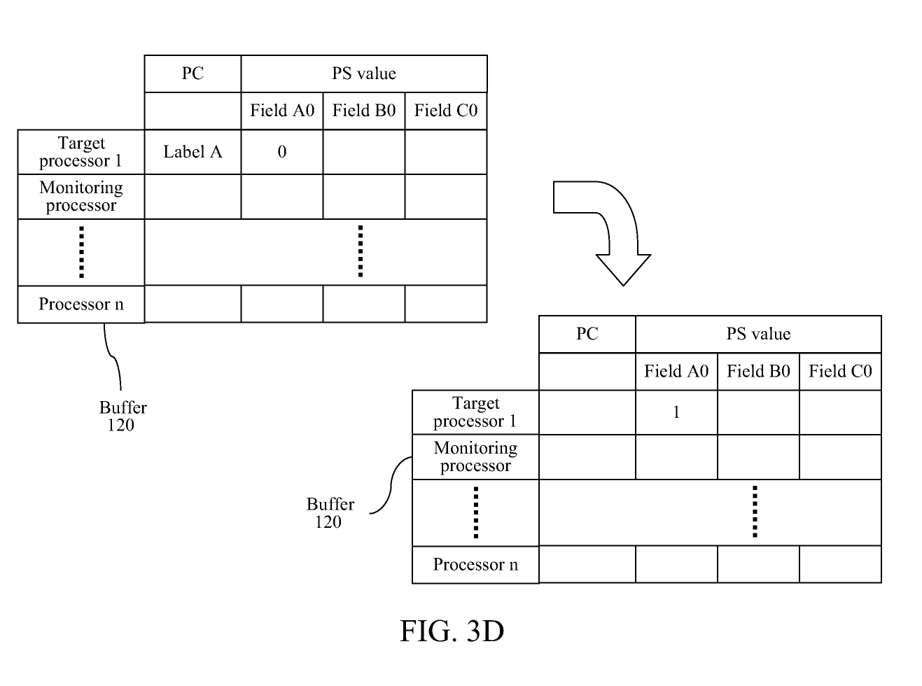

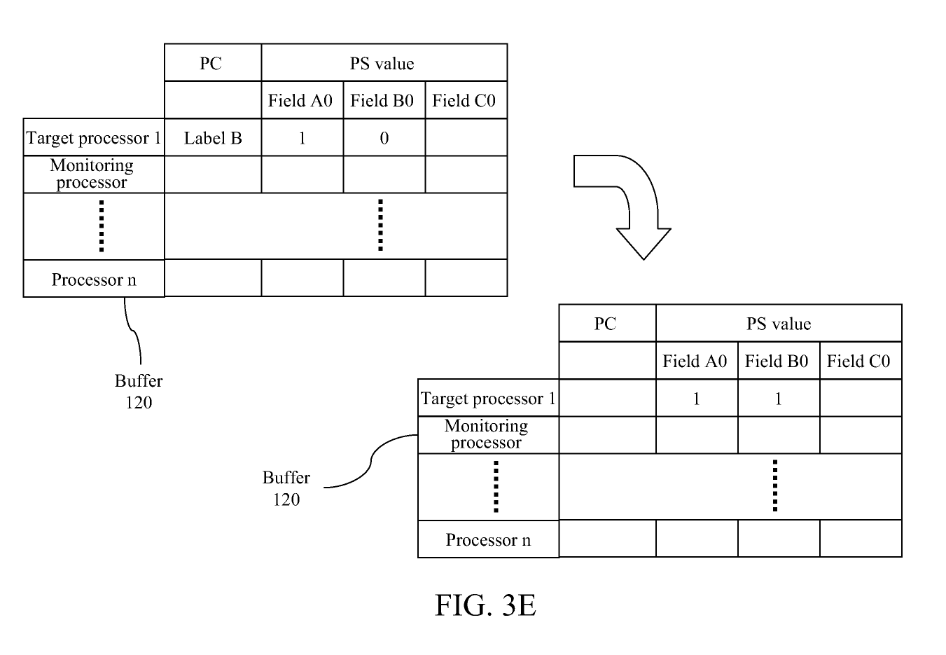

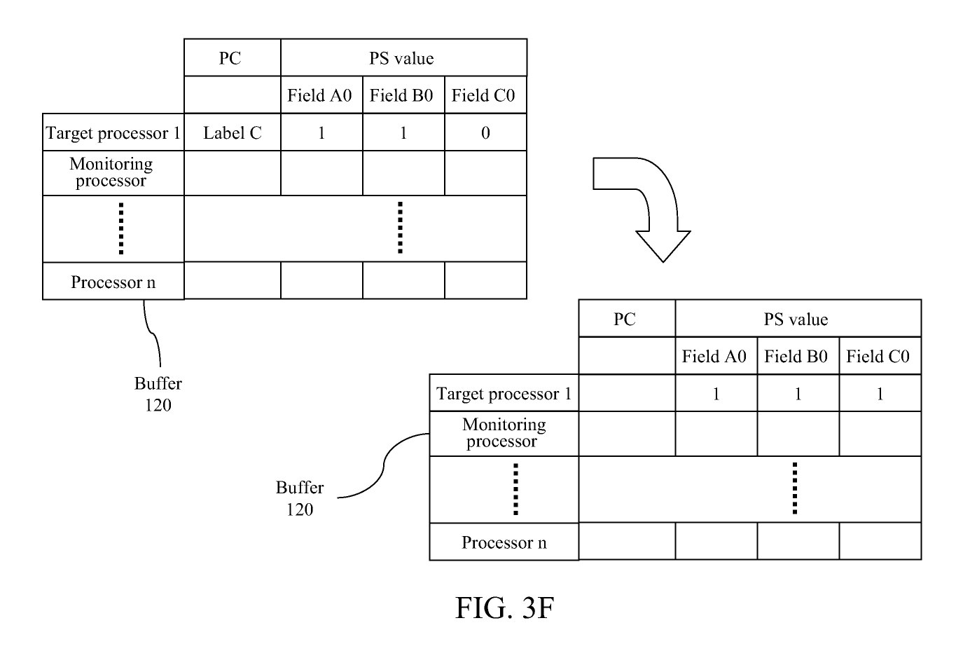

In order to clearly describe overall operation of the disclosure, an operation procedure of the monitoring processor 111 and one target processor 112 is described herein, but the number of the target processors 112 is not limited to one. FIG. 3A is a schematic structural view of a salve operation program 131. Referring to FIG. 3A, it is assumed that a processor 2 acts as the monitoring processor 111, and a processor 1 is the target processor 112 and executes slave operation programs 131 of Label A, Label B, and Label C. From a software point of view, different output values are output each time after the target processor 112 completes the salve operation program 131. From a hardware point of view, different pulse signals are generated each time after the target processor 112 completes the salve operation program 131. The monitoring processor 111 (the monitoring processor 111 is PE2 of following pseudo-codes, and the target processor 112 corresponds to PE1 of the pseudo-codes) runs following pseudo-codes of the master operation program:

```
Loop:Repeat Read PE1 port A status
    until Data of port A is “1”
PE1 PC ← Label B
    Repeat Read PE1 port B status
    Until Data of port B is “1”
PE1 PC ← Label C
    Repeat Read PE1 port C status
    Until Data of port C is “1”
PE1 PC ← Label A
go to loop
```

First, the execution flow of the master operation program is that the monitoring processor 111 repeatedly monitors whether the PS value of the target processor 112 is changed (in this example, “0” is changed to “1”). In the pseudo-codes of this embodiment, a loop is used to control an operation sequence of Label A, Label B, and Label C for the target processor 112, but the disclosure is limited thereto. In the procedure of assigning the target processor 112, the execution sequence of the slave operation program 131 is determined through other logic control.

The monitoring processor 111 timely reads whether the PS value of a field A0 in the buffer module 120 is changed into “1”. When the PS value of the field A0 is still “0”, the monitoring processor 111 does not assign the target processor 112 to execute a slave operation program 131-2 of Label B.

When a slave operation program 131-1 of Label A is executed, the field of the corresponding processor in the buffer module 120 is correspondingly identified. FIGS. 3B and 3C are schematic views of the buffer module and overall operation respectively. In FIG. 3B, the PC and the PS value of the target processor 112 are respectively set to be “Label A” and “0”, that is, the monitoring processor 111 assigns the target processor 112 to execute the slave operation program 131-1 of Label A, and sets the operation state value of the target processor 112 to be “0”. In this way, other monitoring processors 111 may observe that this target processor 112 (that is the original processor 1) is used from the buffer module 120. Therefore, the other monitoring processors 111 will not invoke the original processor 1 (that is the target processor 112). Referring to FIG. 3D, after the slave operation program 131-1 of Label A is completed, the PS value is set to be “1”. When the PS value of the field A0 is “1”, the monitoring processor 111 assigns the target processor 112 to execute the slave operation program 131-2 of Label B.

Then, the monitoring processor 111 drives the target processor 112 to execute the slave operation program 131-2 of Label B. Referring to FIG. 3E, the monitoring processor 111 sets the PC and the PS value of the target processor 112 of the buffer module 120 to be “Label B” and “0” respectively. The monitoring processor 111 constantly reads the operation status of the target processor 112 of the buffer module 120, and determines whether the operation status has been changed. When the PS value of a field B0 is “1”, the monitoring processor 111 assigns the target processor 112 to execute a slave operation program 131-3 of Label C.

Similarly, the monitoring processor 111 drives the target processor 112 to execute the slave operation program 131-3 of Label C. Referring to FIG. 3F, the monitoring processor 111 sets the PC and the PS value of the target processor 112 of the buffer module 120 to be “Label C” and “0” respectively. When the PS value of a field C0 is “1”, the monitoring processor 111 assigns the target processor 112 to execute the slave operation program 131-1 of Label A. After the monitoring processor 111 completes the slave operation program 131-3 of Label C, the monitoring processor 111 executes the slave operation program 131-1 of Label A again according to the loop of the master operation program.

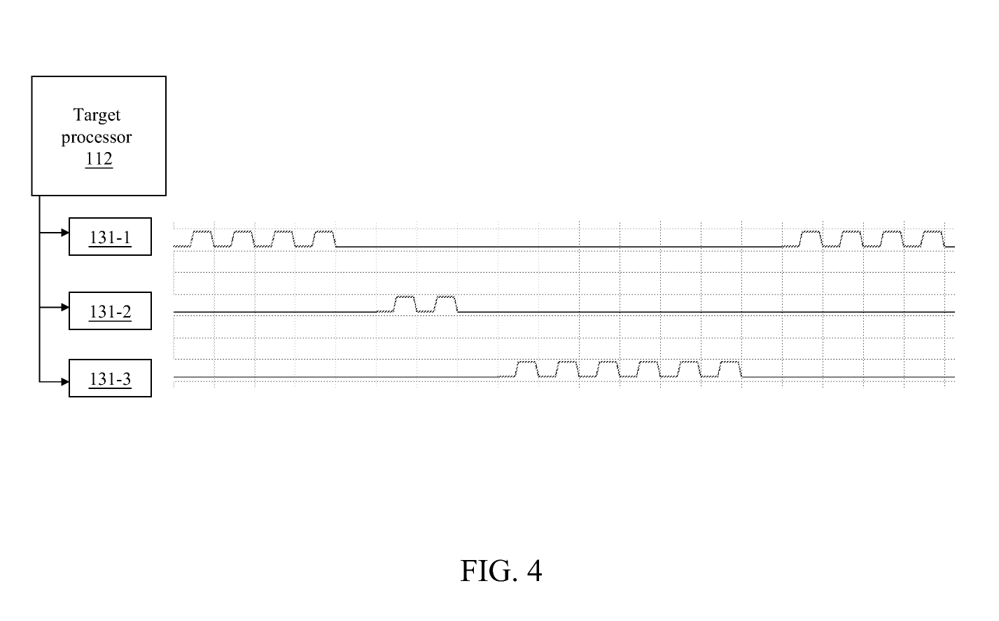

As described above, according to the disclosure, when the control system 100 of the multiprocessor executes the slave operation program 131, in addition to the produced corresponding output values, corresponding pulse signals are output through different slave operation programs as for the hardware. FIG. 4 is a schematic view of the pulse signals in operation according to the disclosure. Referring to FIG. 4, it is assumed that the slave operation program 131-1 of Label A generates 4 pulses, the slave operation program 131-2 of Label B generates 2 pulses, and the slave operation program 131-3 of Label C generates 6 pulses.

In addition to the above embodiments, the disclosure may be further applied to the control system 100 of multiple target processors 112. As described above, in the procedure of executing the master operation program, the monitoring processor 111 may assign different target processors 112 to execute the slave operation program 131 thereof.

The disclosure provides the control method and the system of the multiprocessor, so as to dispatch the operation sequence for executing different operation programs by a plurality of processors. In the disclosure, the processors obtain the use status of the other processors without using an interrupt or polling method. Therefore, according to the disclosure, time consumed for inquiring may be reduced in the allocation procedure of the multiprocessor, thereby improving the operation efficiency of the processors.

What is claimed is:

1. A control method of a multiprocessor, for dispatching an operation sequence for executing different operation programs by a monitoring processor and a plurality of target processors, comprising:
the monitoring processor executing a master operation program;
the monitoring processor obtaining an operation status of the target processors from a buffer;
the monitoring processor selecting at least one target processor; and
the monitoring processor assigning the target processors to execute a corresponding slave operation program, and resetting the operation status of the selected target processors.

2. The control method of the multiprocessor according to claim 1, wherein the operation status at least comprises an identification code, a program counter (PC), a program status (PS) value, and a writing flag or a reading flag.

3. The control method of the multiprocessor according to claim 2, wherein the monitoring processor selects the target processors according to the operation status.

4. The control method of the multiprocessor according to claim 1, wherein the monitoring processor repeats the step of assigning the slave operation program, till the monitoring processor completes the master operation program.

5. The control method of the multiprocessor according to claim 4, wherein after the monitoring processor completes the master operation program, the monitoring processor clears the operation status of the target processors in the buffer.

6. A control system of a multiprocessor, for dispatching an operation sequence for executing different operation programs by a plurality of processors, comprising:
a buffer, for recording an operation status of the processors;
at least one target processor, for writing the operation status of the target processor into the buffer when each target processor executes a slave operation program; and
a monitoring processor, for executing a master operation program, obtaining the operation status of the target processors from the buffer and selecting at least one target processor, and resetting the operation status of the selected target processors, so that the target processors execute the corresponding slave operation program according to the new operation status.

7. The control system of the multiprocessor according to claim 6, wherein the operation status at least comprises an identification code, a program counter (PC), a program status (PS) value, and a writing flag or a reading flag.

8. The control system of the multiprocessor according to claim 6, wherein after the monitoring processor completes the master operation program, the monitoring processor clears the operation status of the target processors in the buffer.

9. The control system of the multiprocessor according to claim 6, wherein the monitoring processor repeats the assigning the slave operation program, till the monitoring processor completes the master operation program.

10. The control system of the multiprocessor according to claim 6, wherein after the monitoring processor completes the master operation program, the monitoring processor clears the operation status of the target processors in the buffer.
